(19) United States
(12) Patent Application Publication
(10) Pub. No.: US 2008/0190914 A1
(43) Pub. Date: Aug. 14, 2008

(54) Portable food storage and preparation device

(75) Inventor: Danielle B. Gibson, Las Vegas, NV (US)

Correspondence Address: Danielle B. Gibson, 7416 Wittig, Las Vegas, NV, 89131, US

(73) Assignee: Danielle B. A. Gibson Revocable Trust, Las Vegas, NV (US)

(21) Appl. No.: 11/704,782

(22) Filed: Feb. 9, 2007

(51) Int. Cl. H05B 6/80

(52) U.S. Cl. 219/689

(57) ABSTRACT

An apparatus for portable food storage and preparation is shown. The apparatus has an impact resistant housing. An insulated portion is contained within the housing and is configured for storage of chilled food and beverage items. A lid covers the insulated portion. A microwave oven is contained within a portion of the housing below the insulated portion and is configured for heating food and beverage items to a desired serving temperature. A control panel is mounted to the housing for controlling the microwave oven. A vent is mounted to the housing for venting excess heat from the microwave oven. An internal power source is provided for operating the microwave oven. A handle is provided for easy transportation of the housing by an individual.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to food preparation and storage. More particularly, the invention relates to a portable device that is able to store food and beverage items at proper and safe temperatures and prepare these food and beverage items for consumption at desired heated temperatures.

### BACKGROUND OF THE INVENTION

Many people pack their lunches or other meals for consumption away from home every day. Often, these meals are dried up, at room temperature, and/or possibly contain deadly, bacteria because these pre-packed meals do not have means for proper storage and heating prior to their consumption. Packing lunch is not just for convenience for some. Many people have not choice by to bring their own lunches to work with them simply because their lunchtime locations can vary day in and day out, and often they may be working in areas where no other food source may be conveniently visited. Also, lunchtime food options are often limited to people while on the job. Frequently these packed lunches are cheap sandwiches that, after remaining bagged up in a lunchbox or sitting on desk, only amount to stale bread and room temperature cold cuts by the time they are eaten.

The need to serve foods at their proper serving temperatures is not based on personal preference alone. If food is not stored at a proper temperature, and then not served at a proper temperature, which may be a completely different temperature than that at which the food was stored, the health of the person who eats this food may be jeopardized. Paper bags and lunch boxes do not adequately maintain proper storing temperatures of food items. As a result, people who resort to such common means of storing and carrying their lunches are at risk to pathogens such as, but not limited to, E. Coli, Salmonella, Listeria monocylognes, and Campylobacter jejuni, which are the four most common, not to mention most deadly, pathogens that standard lunch foods can easily contract when stored within standard containers. These bacterial pathogens can be defeated, however, if the food items are stored at a proper temperature and then served at a proper serving temperature. However, many people do not have access to refrigerators and ovens during their work shifts in order to do this.

In view of the foregoing, there is a need for a device that is able to store food and beverage items at safe temperatures and prepare these food or beverage items at proper temperatures at any location so that a wider variety of food may be available in various locations.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1, 2, 3, and 4 illustrate an exemplary portable food cooling and heating device, in accordance with an embodiment of the present invention. FIG. 1 shows a front perspective view of the device. FIG. 2 shows a front cutaway view of the device illustrating the interior of a cooler. FIG. 3 shows a front perspective view of the device with a lid and a microwave door in open positions. FIG. 4 shows a back perspective view of the device illustrating a battery box and an A/C connection;

FIG. 5 illustrates a close-up view of an exemplary keypad for the operation of the microwave oven in the portable food storage and preparation device, in accordance with an embodiment of the present invention; and

FIG. 6 illustrates a perspective view of an exemplary large, portable cooling and heating device for food and beverage items, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a variety of techniques for implementing an apparatus for portable food storage and preparation is described.

In one embodiment the apparatus comprises a portable ice-chest-type cooler configured for storage of chilled food and beverage items and a portable food preparation device configured for heating food and beverage items to a desired serving temperature, and configured for attachment to the cooler for facilitating easy transportation by an individual. In another embodiment the food preparation device comprises an internal power source for operation. In a further embodiment the food preparation device is configured to utilize an external power source for operation. In another embodiment the food preparation device is a microwave oven. In other embodiments, the microwave oven comprises a control device for user control of an operation of the microwave oven, a vent for venting excess heat from the microwave oven, and the control device comprises a numeric keypad and display. In another embodiment the cooler and the microwave oven are contained within an impact resistant housing. In a further embodiment the cooler comprises a suitable insulating material. Other embodiments comprises a handle for transporting the housing and wheels attachable to the housing for facilitating the transporting.

In yet another embodiment an apparatus for portable food storage and preparation is described. The apparatus comprises a means for storing chilled food and beverage items, a means for heating food and beverage items, and a means for attaching the means for storage and the means for heating for easy transportation. A further embodiment comprises a means for transporting the apparatus.

In still another embodiment, an apparatus for portable food storage and preparation is shown. The apparatus comprises an impact resistant housing, an insulated portion contained within the housing and configured for storage of chilled food and beverage items, a lid covering the insulated portion, a microwave oven contained within a portion of the housing below the insulated portion and configured for heating food and beverage items to a desired serving temperature, a control panel mounted to the housing for controlling the microwave oven, a vent mounted to the housing for venting excess heat from the microwave oven, an internal power source for operating the microwave oven, and a handle for easy transportation of the housing by an individual. In a further embodiment the insulated portion comprises a foam material for insulation. In another embodiment the power source is adaptable to utilize an external power connection. In a further embodiment the control panel comprises a numeric keypad and display. In other embodiments the apparatus comprises wheels for facilitating the transportation, the housing comprises a high impact plastic material, and the external power connection comprises an alternating current A/C connection.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognized a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternatives embodiments do not necessarily imply that the two are mutually exclusive.

The present invention will now be described in detail with reference to embodiments thereof as illustrated in the accompanying drawings.

The preferred embodiment of the present invention comprises a portable, insulated ice-chest-type cooler into which food and beverage items may be stored, and this cooler rests on top of, and attaches to, a microwave oven. The preferred embodiment can store food and beverage items at chilled temperatures and can heat these chilled food and beverage items to desired serving temperatures. In portability of the preferred embodiment enables this cooling and heating to be performed at any location because the device can be easily transported to these locations. The durable and impact-resistant plastic material that houses the preferred embodiment as a single unit protects the microwave oven from impact as well as damages resultant from such impact, thus extending the durability of the preferred embodiment and its usability in any area.

Embodiments of the present invention can enhance the dining options of persons who must partake in meals away from standard dining locations. These embodiments enable persons who travel during their workday, persons who work outdoors, persons who work in remote locations, and persons traveling to remote locations for other reasons to conveniently enjoy hot meals accompanied by cold beverages despite any variations in the atmospheres and offerings of their locations. Persons who work in or visit such locations in such circumstances may broaden their menus of possible food servings despite the assumed limitations of these locations and/or circumstances. Embodiments of the present invention also generally ensure that food items served in unconventional locations may be consumed at safe, recommended serving temperatures.

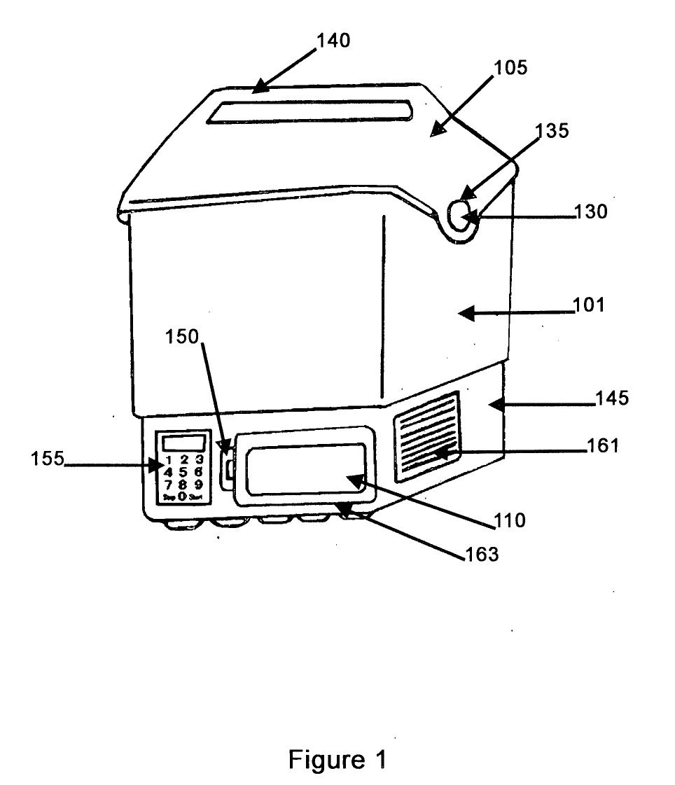

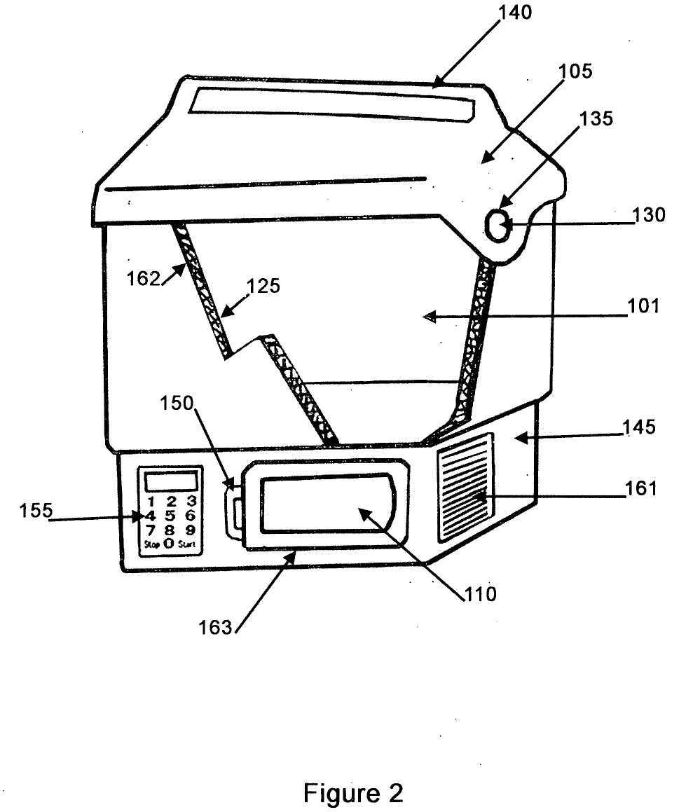

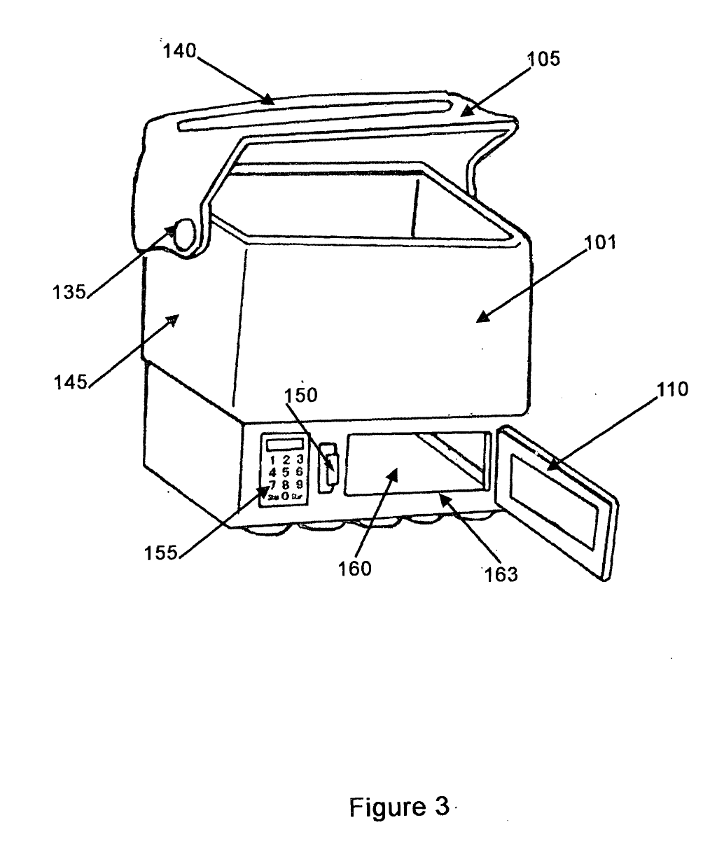

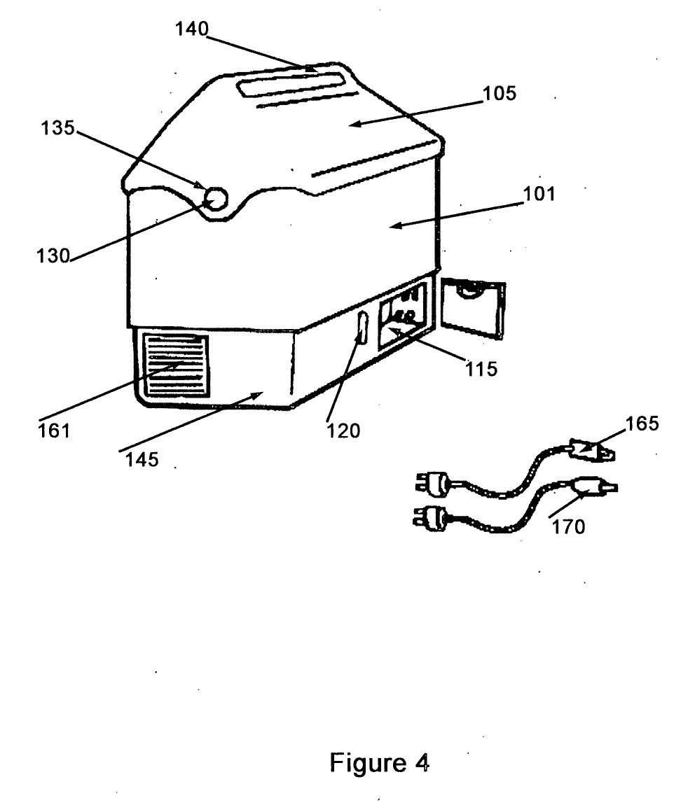

FIG. 1, 2, 3, and 4 illustrate an exemplary portable food cooling and heating device, in accordance with an embodiment of the present invention. FIG. 1 shows a front perspective view of the device. FIG. 2 shows a front cutaway view of the device illustrating the interior of a cooler 101. FIG. 3 shows a front perspective view of the device with a lid 105 and a microwave door 110 in open positions. FIG. 4 shows a back perspective view of the device illustrating a battery box 115 and an A/C connection 120. In the present embodiment, the device comprises an insulated cooler 101 made of high-density polyethylene (HDPE) in open shell format with a polyurethane (PU) foam material 125 within the open space of this shell to act as insulator. The base portion of cooler 101, not inclusive of lid 105, measures approximately fourteen inches in height by eighteen inches in width by sixteen inches in depth (14″×18″×16″). Those skilled in the art, in light of the present teachings, will recognize that cooler 101 may be constructed of various different materials such as, but not limited to, various plastic materials, including but not limited to high impact polystyrene (HIPS), acrylonitrile butadiene styrene (ABS), rigid polyvinyl chloride (PVC) and high density polyethylene (HDPE). Cooler 101 may also be made in various sizes and have various different known insulation materials. In some embodiments the device may by made in formats that use metal materials to form the cooler and container frame.

In the present embodiment, lid 105, which seals cooler 101, is of a pivoting format, made of the same HDPE material as cooler 101, and mounted upon cooler 101 by a free-rotating axis. In alternate embodiments, the lid may be attached to the cooler with various other means: for example, without limitation, the lid may slide back and forth in a slot formed in the body of the cooler, or the lid may be attached to the body of the cooler with hinges. In the present embodiment, lid 105 is sealable upon cooler 101 by projection of cooler-mounted, spring-loaded buttons 130 through aligned apertures 135 of lid 105. In alternate embodiments the lid may be secured by various other means such as, but not limited to, plastic or metal latches or the lid may snap tightly into or onto the body of the cooler. An open handle 140 that is easy to grip forms the top plane of lid 105.

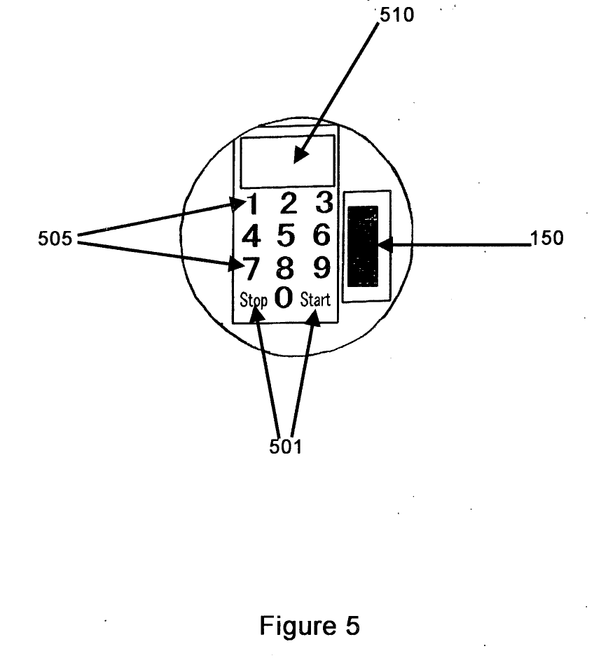

A small-sized microwave oven 145 is contained within the same housing as cooler 101, and is positioned directly below cooler 101. In the preset embodiment, microwave oven 145 has an individual size of an approximate ten-inch height by eighteen-inch width by sixteen-inch depth (10″×18″×16″). However, microwave ovens in alternate embodiments may be various different sizes according to factors such as, but not limited to, the size of the cooler portion of the device or the application of the device. In the present embodiment, the interior of microwave oven 145 is accessible by hinged door 110 via a push-button release 150 on a facing of the device. This same facing area also bears a keypad 155. Keypad 155 is shown by way of example in FIG. 5.

In the present embodiment, microwave oven 145 comprises standard equipment of a magnetron, magnetron control circuit and a waveguide, which provide the controlled radiation within a cooking chamber 160 of microwave oven 145. The radiation produced by microwave oven 145 generates approximately seven hundred watts (700 W) of microwave power at a frequency of two-thousand-four-hundred-and fifty megahertz (2,450 MHz), and at a wavelength of twelve-and-twenty-four-hundredths of centimeters (12.45 cm). Depending on the particular embodiment, the magnetron control circuit in the microwave portion of the device may or may not comprise a microcontroller. In alternate embodiments more or less powerful microwave ovens may be used according to the specific application of the device. In the present embodiment, the excess heat from microwave oven 145 is vented through a vent 161. Some embodiments may comprise a fan blower to ensure full dispensation of waste heat produced by the microwave oven with the purpose of avoiding affects of such waste heat on the items stored within the cooler. Some embodiments may have a stirrer fan to dissipate the energy of microwave oven 145 throughout the microwave chamber, and/or a carousel plate to rotate the contents while the microwave process. Also, depending on the embodiment, the microwave oven may or may not include a defrost setting.

In the present embodiment, the exterior of microwave oven 145 is encased within a high-density polyethylene (HDPE) frame 162 extending from the exterior walls and bottom surface of cooler 101. The cooler and microwave-encasing frame 162 may be made of various plastic materials, including but not limited to high impact polystyrene (HIPS), acrylonitrile butadiene styrene (ABS), rigid polyvinyl chloride (PVC) and high-density polyethylene (HDPE). An opening 163 on the front wall of frame 162 surrounding microwave oven 145 is featured in order to allow front access through hinged door 110. In alternate embodiments, instead of being contained in a single-unit housing, the cooler and microwave oven may be attached to one another by various means such as, but not limited to adhesives, bolts or screws.

FIG. 5 illustrates a close-up view of an exemplary keypad 155 for the operation of microwave oven 145 in the portable food storage and preparation device, in accordance with an embodiment of the present invention. In the present embodiment, keypad 155 comprises control buttons 501 and numeric buttons 505, which are touch-sensitive and flush to the facing, as well as a display screen 510 of light-emitting diodes (LED). Those skilled in the art, in light of the present teaching, will recognize that control buttons 501 and numeric buttons 505 may not be flush to the facing for example, without limitation these buttons may be spring-loaded buttons. Alternate embodiments may use dials or other means of input instead of buttons. Also, some embodiments may not include a display, particularly embodiments having dials instead of buttons. Push button release 150 is also illustrated by way of example of FIG. 5.

In typical usage of the present embodiment, a user may store food and beverage items within cooler 101. Ice and other cooling aids may also be stored in cooler 101. The device may then be carried by the user to any location with the simplicity and convenience of a standard lunch box or traditional cooler. If the stored food and/or beverage items are in need of heating at time of consumption, these items may be placed within cooking chamber 160 of microwave oven 145. Microwave oven 145 may then be set to operate for an appropriate time for the heating of such food and/or beverage items by using keypad 155 to type in this time and pressing a start button. When this heating preparation is complete, the food and/or beverage items may be consumed by the user. The device can be powered by direct current via batteries in battery box 115. The batteries used in embodiments of the present invention may or may not be rechargeable. The present embodiment may also be electrically powered by alternating current through A/C connection 120 and A/C cord 165. In some embodiments the device may be powered by a cigarette lighter of an automobile using a power cord 170 that is designed to be plugged into a vehicle cigarette lighter. A/C cord 165 and power cord 170 are shown in way of example in FIG. 4.

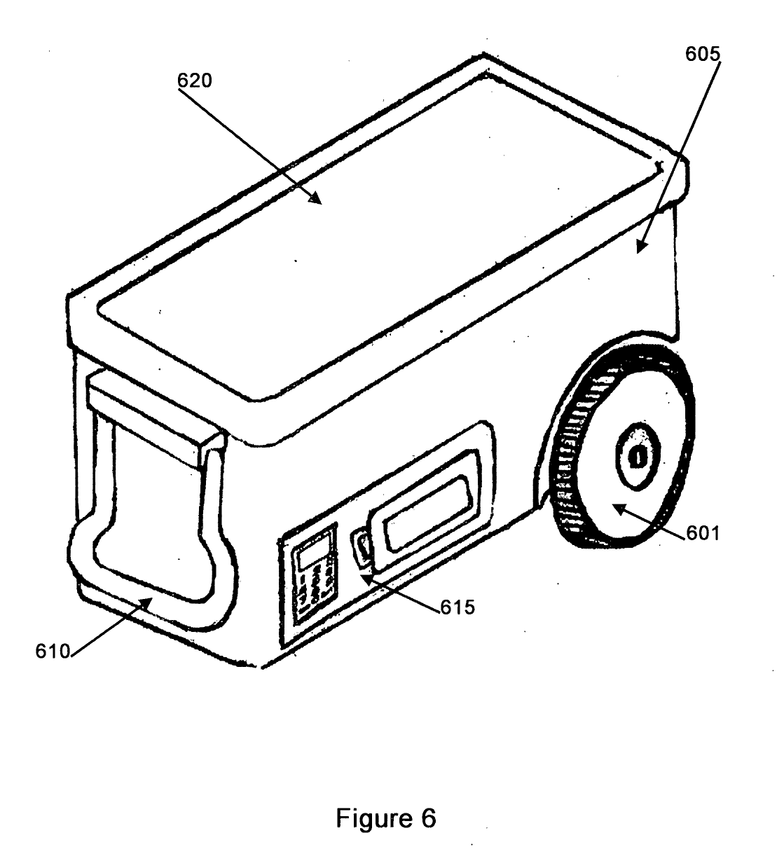

FIG. 6 illustrates a perspective view of an exemplary large, portable cooling and heating device for food and beverage items, in accordance with an embodiment of the present invention. The present embodiment includes, without limitation, wheels 601 to aid immobility, as well as to provide space for venting circulation by raising the device off of the ground. Wheels 601 may or may not be lockable. The present embodiment has two wheels 601, one on each side of a cooler 605; however, alternate wheeled embodiments may have various different wheel configurations, for example, without limitation three wheels with two in the back and one in the front or four wheels with one wheel on each corner of the device. In the present embodiment a pivoting handle 610 is attached to cooler 605 so that handle 610 rotates up when the user is pulling the device along the ground, and handle 610 rotates down out of the way when not in use. Alternate wheeled embodiments may have telescoping handles to easily allow wheeled transport.

In the present embodiment, a microwave oven 615 is housed within a plastic frame of cooler 605. Microwave oven 615 is located near the bottom of cooler 605 so that storage space in cooler 605 remains above microwave oven 615 where the user can access the storage space by opening a lid 620. Lid 620 is hinged; however, in alternate embodiments lids may open and close differently. For example, without limitation, the lid may slide back and forth in tracks in the cooler, or the lid may lift off of the cooler and snap tightly into place on the cooler. In alternate embodiments the frame and the lid may be made of various materials such as, but not limited to, various plastics or metals.

The typical use of the present embodiment is similar to the use of the embodiment shown by way of example in FIGS. 1 through 5. The user stores food or beverage items in cooler 605. The user may pull the device along on wheels 601 to a desired location with handle 610. Then, if a food or beverage item requires heating, the user may heat the item in microwave oven 615. Microwave oven 615 may be battery operated, may have an A/C power cord to be plugged into an A/C power source, or both.

Alternate embodiments may include, without limitation, support legs for the device to rest upon. Support legs also provide venting circulation by raising the device off of the surface that the device is resting upon. Support legs may be made of various materials such as, but not limited to, plastic, metal or wood. These support legs may or may not be foldable.

Other alternate embodiments may include, without limitation, various other small appliances such as, but not limited to, convection microwaves, toaster ovens, and/or other applicable heating/cooking appliances.

Having fully described at least one embodiment of the present invention, other equivalent or alternative means for implementing a portable food storage and preparation device according to the present invention will be apparent to those skilled in the art. For example, those skilled in the art will readily recognize, in light of the teaching of the present invention, that the cooler portion of the device may be various shapes and sizes. Also, by way of example and not limitation, an alternate embodiment may comprise a cooler constructed of a flexible material instead of a hard-sided cooler. Various alternate embodiments may differ in the location of the microwave oven in relation to the cooler. For example, without limitation, the microwave oven and the cooler may be side by side. All such alternative embodiments are contemplated as being within the scope of the present invention. The invention has been described above by way of illustration, and the specific embodiments disclosed are not intended to limit the invention to the particular forms disclosed. The invention is thus to cover all modifications, equivalents, and alternatives falling within the spirit and scope of the following claims.

1. An apparatus for portable food storage and preparation, the apparatus comprising:
a portable ice-chest-type cooler configured for storage of chilled food, beverage items, ice and other cooling aids, said cooler comprising an open shell format a lid and a handle fixedly attached for transportation; and
a portable food preparation device comprising dimensions smaller than said cooler, configured for heating food and beverage items to a desired serving temperature, and fixedly attached to a bottom of said cooler for facilitating easy transportation of the apparatus by an individual.

2. The apparatus as recited in claim 1, in which said food preparation device comprises an internal power source for operation.

3. The apparatus as recited in claim 2, in which said food preparation device is configured to utilize an external power source for operation.

4. The apparatus as recited in claim 3, in which said food preparation device is a microwave oven.

5. The apparatus as recited in claim 4, in which said microwave oven comprises a control device for user control of an operation of said microwave oven.

6. The apparatus as recited in claim 5, in which said microwave oven comprises a vent for venting excess heat from said microwave oven.

7. The apparatus as recited in claim 6, in which said control device comprises a numeric keypad and display.

8. The apparatus as recited in claim 7, in which said cooler and said microwave oven are contained within an impact resistant housing.

9. The apparatus as recited in claim 8, in which said cooler comprises a suitable insulating material in an open space of said shell.

10. (canceled)

11. The apparatus as recited in claim 11, further comprising wheels attachable to said housing for facilitating said transporting.

12. An apparatus for portable food storage and preparation, the apparatus comprising:
means for storing chilled food, beverage items, ice and other cooling aids;
means for heating food and beverage items; and
means for fixedly attaching said means for storage and said means for heating for easy transportation.

13. The apparatus as recited in claim 12, further comprising means for transporting the apparatus.

14. An apparatus for portable food storage and preparation, the apparatus comprising:
an impact resistant housing;
an insulated portion contained within said housing and configured for storage of chilled food, beverage items, ice and other cooling aids, said insulated portion comprising an open shell format;
a lid covering said insulated portion;
a microwave oven comprising dimensions smaller than said insulated portion, contained within a portion of said housing below said insulated portion, fixedly attached to a bottom of said insulated portion and configured for heating food and beverage items to a desired serving temperature;
a control panel mounted to said housing for controlling said microwave oven;
a vent mounted to said housing for venting excess heat from said microwave oven;
an internal power source for operating the microwave oven; and
a handle fixedly attached for easy transportation of said housing by an individual.

15. The apparatus as recited in claim 14, in which said insulated portion comprises a foam material for insulation in an open space of said shell.

16. The apparatus as recited in claim 14, in which said power source is adaptable to utilize an external power connection.

17. The apparatus as recited in claim 14, in which said control panel comprises a numeric keypad and display.

18. The apparatus as recited in claim 14, further comprising wheels for facilitating said transportation.

19. The apparatus as recited in claim 18, in which said housing comprises a high impact plastic material.

20. The apparatus as recited in claim 16, in which said external power connection comprises an alternating current A/C connection.
